(19) United States
(12) Patent Application Publication
(10) Pub. No.: US 2007/0247798 A1
(43) Pub. Date: Oct. 25, 2007

(54) Display having a variable display size for use in portable electronic devices and methods for controlling same

(75) Inventor: Willie L. Scott II, Austin, TX (US)

Correspondence Address: HARRINGTON & SMITH, PC, 4 RESEARCH DRIVE, SHELTON, CT, 06484-6212, US

(73) Assignee: International Business Machines Corporation

(21) Appl. No.: 11/409,462

(22) Filed: Apr. 20, 2006

(51) Int. Cl. G06F 1/16

(52) U.S. Cl. 361/683

(57) ABSTRACT

The invention concerns a display for use in, for example, small electronic devices such as notebook computers. The display of the invention has a main display panel and an auxiliary display panel, wherein the auxiliary display panel is slidably mounted in a housing behind the main display panel when not in use. A user of the display of the invention can selectively extend the auxiliary display panel from behind the main display panel to increase the amount of display area available to the user. A sensor mounted in the housing determines how far the auxiliary panel has been extended and informs the software controlling display operations how much additional display area has been made available for display operations. In an alternate embodiment, two auxiliary panels are slidably mounted in the housing behind the main panel and can be extended to use positions on the left and right sides of the main display panel of the display. In another alternate embodiment, an auxiliary display panel is mounted behind the main display panel in a housing and can be slidably extended to a position above the main display panel.

### TECHNICAL FIELD

The invention generally concerns displays for use with portable electronic devices like notebook computers, and more particularly concerns a display having a main display panel and at least one auxiliary display panel, wherein the at least one auxiliary display panel is slidably extendable from a storage position behind the main display to a use position adjacent to the main display panel.

### BACKGROUND

It is well-known that in today's business environment, consumers have come to appreciate the many benefits of mobile computing in its various forms (e.g., PDAs, mobile phones, notebook computers, etc.). Mobile computing has played a key role in the increasing acceptance of the mobile office—no longer must one be stationed in the office to be productive. Accordingly, mobile computing vendors have been under considerable pressure to meet increasing consumer expectations concerning mobile computing products and capabilities.

Mobile computing consumers want all of the functionality of the office, but available anywhere, and at any time. Perhaps the most key component of the mobile office is the notebook computer. With smaller size, ease of portability and comparable computing power to that of desktop computers, notebook computers have achieved widespread acceptance in the home and workplace. In fact, it is expected that desktop computers will lose further market share to notebook computers. This being the case, producers of notebook computers are under continual pressure to increase the functionality of notebook computers.

Present notebook computers compare favorably with state-of-the-art desktop computers in most performance categories. Notebook processor speeds have parity with desktops; notebooks can store similar amounts of data due to compact notebook hard drives; and notebook computers have CD/DVD±RW drives. In short, notebook computers have similar capabilities as desktop computers with a few exceptions the most noticeable being the lack of large monitor viewable areas. For example, over the past few years desktop-specific LCD monitors with 24″ and 30″ diagonal screen dimensions have been introduced. In addition, a number of LCD and plasma televisions have analog VGA or digital DVI inputs and can be used in combination with desktop computers. The screen diagonals of computer-capable televisions vary anywhere from 26″ up to 50″. Accordingly, those accustomed to having access to large-screen monitors associated with desktop computers are often frustrated when confronted with the small displays typical of notebook computers. The largest notebook computer displays have diagonals of 17″, with 15″ and 14″ being more typical.

Some progress has been made in providing notebook computers with larger display areas. These solutions, however, are problematic. Typically, larger display areas are achieved for notebook computers by providing auxiliary display panels that can swing outward from a storage position behind the main display panel of the notebook computer. A problem with this arrangement arises from typical mobile computing environments—such as, for example, a coach class cabin seat in an aircraft—where an auxiliary display panel equal in size to the main display panel may be more than a cramped computing environment can accommodate. In addition, proposed arrangements would be bulky, and balky to operate.

Accordingly, those skilled in the art seek notebook computers having displays with larger viewable areas. In particular, those skilled in the art seek notebook computers having displays with larger viewable areas that can accommodate and be adapted to the often cramped nature of mobile computing environments.

### SUMMARY OF THE PREFERRED EMBODIMENTS

The foregoing and other problems are overcome, and other advantages are realized, in accordance with the following embodiments of the invention.

A first embodiment of the invention comprises a display having a variable display size. The display is mounted in a housing having a front side, a back side, two lateral sides, top and bottom sides, wherein at least one of the top, bottom or lateral sides has a slot. The front, back, lateral, top and bottom sides define a hollow cavity within the housing. A main display panel is mounted on the front side of the housing, and at least one auxiliary display panel is slidably extendable from a storage position within the hollow cavity of the housing. The at least one auxiliary display panel is mounted on a slider mounting. The at least one auxiliary display panel slides through the slot to a use position and slides back through the slot to the storage position when not in use. A variable amount of the at least one auxiliary display panel is available for display purposes depending on how far the at least one auxiliary display panel is extended when in use. The display further comprises at least one sensor for detecting a current position of the at least one auxiliary display panel. When the auxiliary display panel is in a storage position the sensor generates a message indicating that the at least one auxiliary display panel is in the storage position and not available for display purposes. When in a use position, the sensor detects how far the at least one auxiliary display panel is extended, the level of extension indicating an amount of the at least one auxiliary panel which is visible and available for display purposes. The sensor generates a message indicating the level of extension.

A second embodiment of the invention comprises an electronic device having a display with a variable display size. The display comprises a housing having a front side, a back side, two lateral sides, top and bottom sides, wherein at least one of the top, bottom or lateral sides has a slot. The front, back, lateral, top and bottom sides define a hollow cavity within the housing. A main display panel is mounted on the front side of the housing and at least one auxiliary display panel is slidably extendable from a storage position within the hollow cavity of the housing. The at least one auxiliary display panel is mounted on a slider mounting. The at least one auxiliary display panel slides through the slot to a use position and slides back through the slot to the storage position when not in use. A variable amount of the at least one auxiliary display panel is available for display purposes depending on how far the at least one auxiliary display panel is extended when in use. The display further comprises at least one sensor for detecting a current position of the at least one auxiliary display panel. When in a storage position the sensor generates a message indicating that the at least one auxiliary display panel is in a storage position and not available for display purposes. When in a use position, the sensor detects how far the at least one auxiliary display panel is extended, the level of extension indicating an amount of the at least one auxiliary panel which is visible and available for display purposes. The sensor generates a message indicating the level of extension. The electronic device further comprises a content generating component to generate content for display on the display; a memory storing a computer program; and a digital processing apparatus for executing the computer program. When the computer program is executed the following operations are performed: if the at least one auxiliary display panel is in a storage position, the digital processing apparatus receives a message from the sensor indicating that the at least one auxiliary display panel is in a storage position; and allocates the content for display to the main display panel; and if the at least one auxiliary display panel is in a use position, the digital processing apparatus receives a message from the sensor indicating the level of extension of the at least one auxiliary display panel; and allocates the content for display to the main display panel and the at least one auxiliary display panel in dependence on the message.

A third embodiment of the invention comprises a signal-bearing medium tangibly embodying a program of machine-readable instructions executable by a digital processing apparatus of a computer system to perform operations for controlling display operations across a composite display comprised of a main display panel and at least one auxiliary display panel of variable dimensions, the operations comprising: receiving a signal indicating that the at least one auxiliary panel has been extended; receiving a signal indicating how much of the at least one auxiliary panel has been extended, wherein the main display panel and the extended portion of the at least one auxiliary display panel form a new effective display; and allocating content for display to the extended portion of the at least one auxiliary display panel and the main display panel.

In conclusion, the foregoing summary of the embodiments of the present invention is exemplary and non-limiting. For example, one skilled in the art will understand that one or more aspects or steps from one embodiment can be combined with one or more aspects or steps from another embodiment to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts in a partial cut-away view a notebook computer incorporating a display constructed in accordance with the invention;

FIG. 2 depicts in a cut-away view display mechanisms incorporated in a display of a notebook computer, wherein the display is constructed in accordance with the invention;

FIG. 3 depicts a display of a notebook computer constructed in accordance with the invention; and

FIG. 4 is a flowchart depicting a method operating in accordance with the invention.

### DETAILED DESCRIPTION OF THE PREFERRED EMBODIMENTS

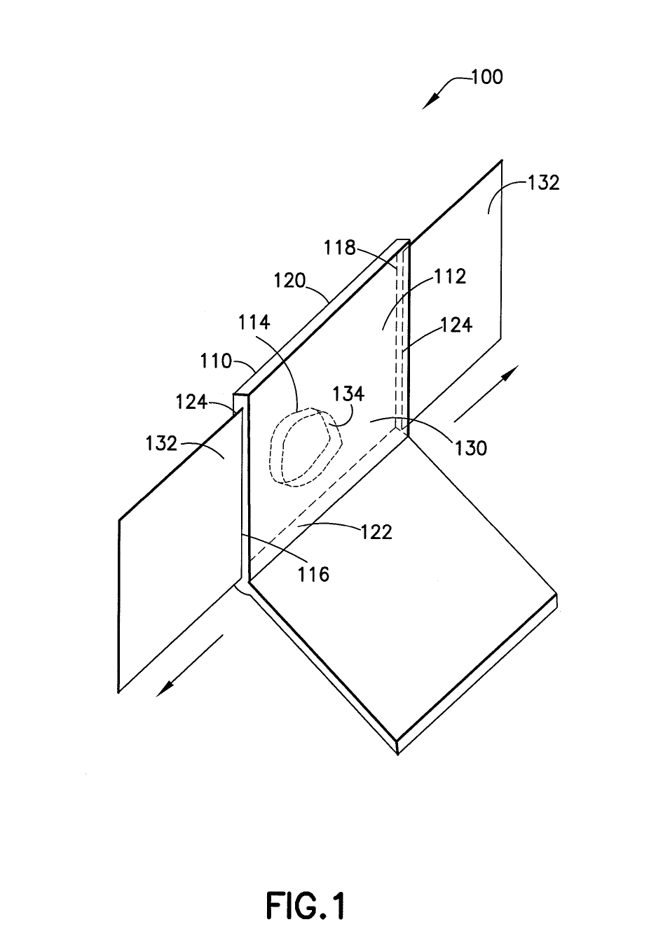

FIG. 1 depicts an embodiment of the invention. A display housing 110 is mounted in a notebook computer 100. The display housing 110 has a front side 112, a back side 114, two lateral sides 116, 118 and top 120 and bottom 122 sides. As used herein, “side” refers to both a physical element and to a logical portion of the display housing 110 for orientation purposes. A main display panel 130 is mounted in the front side 112 of display housing 110. As is apparent in FIG. 1, two auxiliary display panels 132 are slidably extendable from a storage position within the display housing 110. The storage position coincides with a hollow cavity 134 formed by the front 112, back 114, lateral 116, 118, top 120 and bottom 122 sides of the display housing. The auxiliary display panels 132 slidably extend through slots 124 in the lateral sides 116, 118 from a storage position to use positions.

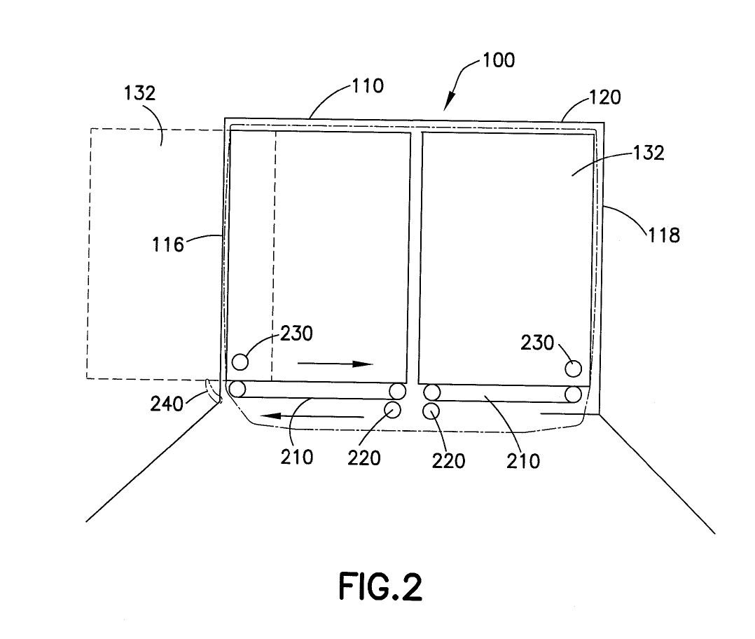

Although two auxiliary display panels 132 are depicted in the embodiment shown in FIG. 2, this is exemplary and one or more auxiliary display panels 132 may be used in embodiments of the invention. In addition, although the auxiliary display panels are shown extending outward from the housing on the left and right sides of the main display panel 132, other arrangements may be used. For example, a single auxiliary display panel may be arranged to extend upwardly through a slot in top side 120. Alternatively, such an upwardly-extending display panel may be combined with the two laterally-extending display panels depicted in FIG. 1 to provide a total of three auxiliary display panels.

In addition, the display of the invention is shown integrated in an electronic device (notebook computer 100) in FIG. 1. The display of the invention also can be implemented as a stand-alone device that may be coupled to an electronic device through a cable or wireless connection.

Further, the display of the invention is shown incorporated in a notebook computer 100 in FIG. 1. In other embodiments, the display may be incorporated in a personal digital assistant; a portable DVD player; a portable computer game play station; a global position system unit; a navigation unit; or as a stand-alone display for incorporation in, for example, an automobile.

FIG. 2 depicts additional details of the invention in a cut-away view. The auxiliary display panels 132 are slidably mounted on slider mounts in FIG. 2, which comprise track and gear mechanisms 210. In the embodiment depicted in FIG. 2, the track and gear mechanisms 210 are powered by motors 220, although this is an optional aspect of the invention. In other embodiments, motive force for moving the auxiliary display panels would be provided by a user sliding the auxiliary display panels with his hands.

A particular advantage of the invention is that a user can select the amount of additional display area to be used in performing display operations by extending the display to a desired level of extension. This is particularly advantageous in mobile work environments that are cramped; in such situations a user can select only the amount of additional display area that the work environment can accommodate.

In order to achieve this aspect of the invention, sensors 230 operate to detect the distance the auxiliary display panels have been extended. The sensors 230 also operate to detect when the auxiliary display panels have been returned to a storage position. The sensors 230 generate various messages for use by a graphic processing system to determine how to allocate content for display across the main display panel and the auxiliary display panels. For example, if the auxiliary display panels are in storage positions (not in use), then the sensors 230 would generate a message indicating this and the graphic processing system of an electronic device would allocate content for display to the main display panel. Alternatively, if the auxiliary display panels are extended only a partial amount of their full extent, the sensors 230 would generate a message indicating that only a partial amount of the auxiliary display panels is available to perform display operations. In such a situation, the content available for display would be allocated between the visible portions of the auxiliary display panels and the main display panel. If the auxiliary display panels are fully extended, the sensors 230 would generate a message indicating this, and the full extent of the auxiliary display panels and the main display panel would be used for display purposes.

In various embodiments sensors 230 comprise optical or electromechanical linear position transducers well-known to those skilled in the art. In one embodiment where an optical linear position transducer is used, a light source and light sensor would be mounted inside the housing adjacent to an edge of the auxiliary display panel. A linear gauge would be positioned along the edge of the auxiliary display panel. Light generated by the light source would reflect off of the linear gauge and be sensed by the light sensor. The information recovered from the gauge would indicate how far the auxiliary display panel has been moved.

Another aspect of the invention is depicted in FIG. 2. The partially-extended auxiliary display panel 132 is maintained in place by a retention mechanism 240. Many retention mechanisms can be used in embodiments of the invention. For example, a ratchet and pawl mechanism can be used as the retention mechanism.

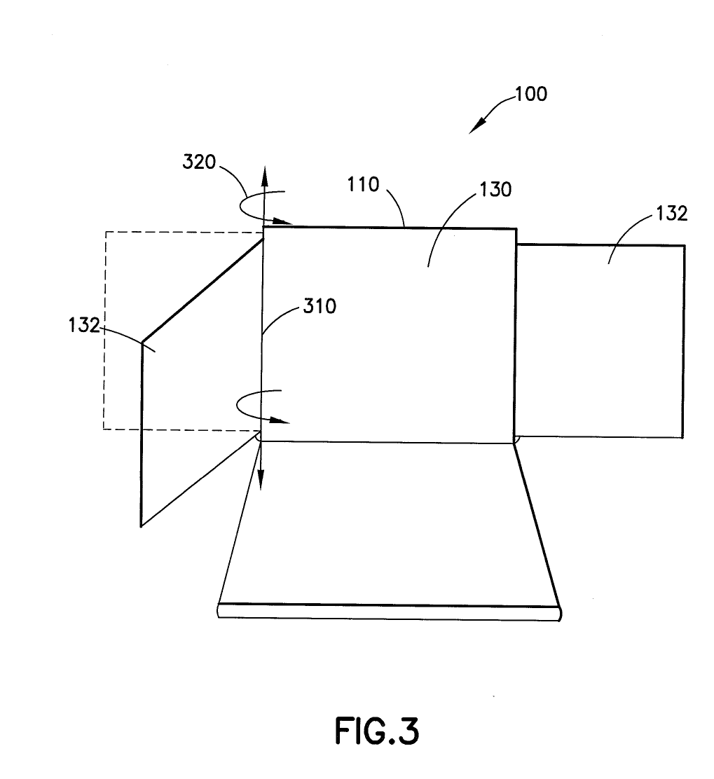

FIG. 3 depicts a further aspect of the invention. In particular, in embodiments of the invention the auxiliary display panels 132 may be pivotally mounted on a pivot mounting 310. In such an embodiment, the auxiliary display panels would be operable to pivot about an axis 320 coincident with the pivot mounting 310 when maximally extended.

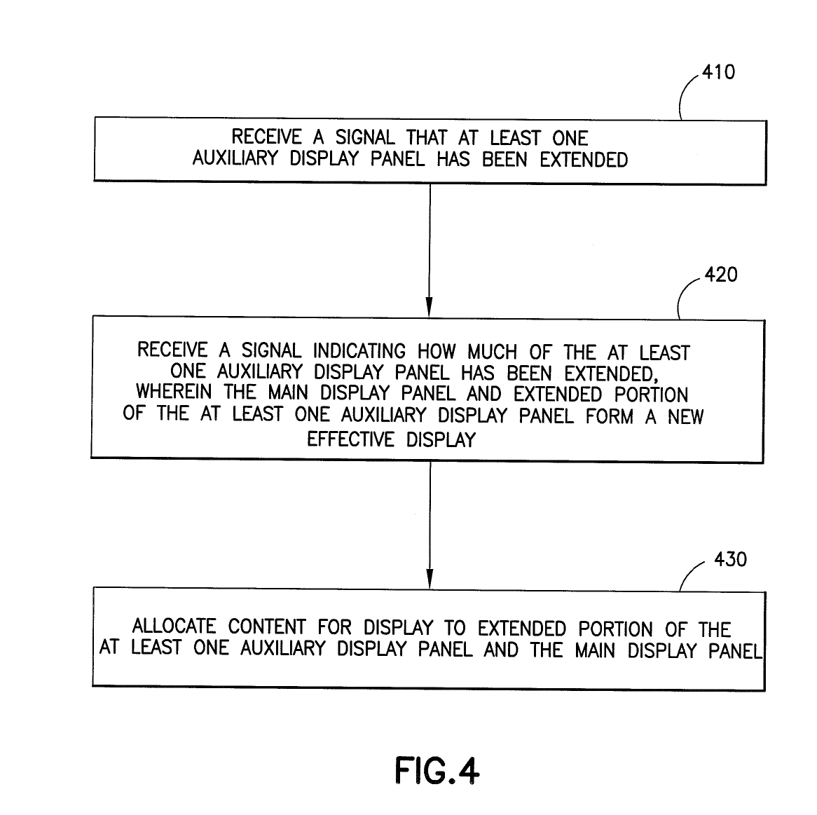

FIG. 4 depicts a method operating in accordance with the invention. The method is operable in an electronic device having a display constructed in accordance with the foregoing teachings. The methods are implemented in a program stored in a computer memory, and the program is executable by a digital processing apparatus of the electronic device. When the computer program is executed the following operations are performed. At step 410, the digital processing apparatus receives a signal from a sensor 230 indicating that at least one auxiliary display panel has been extended. Next, at step 420, the digital processing apparatus receives a signal indicating how much of the at least one auxiliary display panel has been extended, wherein the main display panel and extended portion of the at least one auxiliary display panel form a new effective display. Then, at step 430, the digital processing apparatus allocates content for display to the extended portion of the at least one auxiliary display panel and the main display panel.

One of ordinary skill in the art will understand that the methods depicted and described herein can be embodied in a tangible machine-readable memory medium. A computer program fixed in a machine-readable memory medium and embodying a method or methods of the present invention perform steps of the method or methods when executed by a digital processing apparatus coupled to the machine-readable memory medium. Tangible machine-readable memory media include, but are not limited to, hard drives, CD- or DVD-ROM, flash memory storage devices or in a RAM memory of a computer system. A machine-readable memory medium tangibly embodying such a computer program comprises an embodiment of the present invention.

Thus it is seen that the foregoing description has provided by way of exemplary and non-limiting examples a full and informative description of the best methods and apparatus presently contemplated by the inventors for providing a display having a variable display area for use in combination with portable electronic devices. One skilled in the art will appreciate that the various embodiments described herein can be practiced individually; in combination with one or more other embodiments described herein; or in combination with displays or portable electronic devices differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

What is claimed is:

1. A display having a variable display size, the display comprising:
a housing having a front side, a back side, two lateral sides, top and bottom sides, wherein at least one of the top, bottom or lateral sides has a slot, the front, back, lateral, top and bottom sides defining a hollow cavity within the housing;
a main display panel mounted on the front side of the housing;
at least one auxiliary display panel slidably extendable from a storage position within the hollow cavity of the housing, the at least one auxiliary display panel mounted on a slider mounting, wherein the at least one auxiliary display panel slides through the slot to a use position and slides back through the slot to the storage position when not in use, and wherein a variable amount of the at least one auxiliary display panel is available for display purposes depending on how far the at least one auxiliary display panel is extended when in use; and
at least one sensor for detecting a current position of the at least one auxiliary display panel, wherein when in a storage position the sensor generates a message indicating that the at least one auxiliary display panel is in a storage position and not available for display purposes, and when in a use position, the sensor detects how far the at least one auxiliary display panel is extended, the level of extension indicating an amount of the at least one auxiliary panel which is visible and available for display purposes and the sensor generates a message indicating the level of extension.

2. The display of claim 1 wherein the slider mounting comprises a track and gear mechanism.

3. The display of claim 1 wherein the slider mounting is powered by a motor.

4. The display of claim 1 wherein the slider mounting further comprises a slide retention mechanism for retaining the at least one auxiliary display panel at a particular level of extension when the at least one auxiliary display panel is in use.

5. The display of claim 1 wherein the at least one auxiliary display panel is pivotally mounted coincident with an axis, wherein when maximally extended the at least one auxiliary display panel is operable to pivot about the axis.

6. The display of claim 5 wherein the display further comprises a pivot retention mechanism for retaining the at least one auxiliary display panel at a particular pivot position.

7. The display of claim 1 wherein the two lateral sides have slots and the at least one auxiliary display panel further comprises two auxiliary display panels, the two auxiliary display panels being slidably extendable from storage positions to use positions through the slots in the two lateral sides.

8. The display of claim 7 wherein the two auxiliary display panels are each pivotally mounted on pivot mounts, the pivot mounts coincident with axes, and wherein when maximally extended the two auxiliary display panels are operable to pivot about their respective axes.

9. The display of claim 7 wherein the two auxiliary display panels comprise first and second auxiliary display panels and at least one of the top or bottom sides have a slot, and wherein the at least one auxiliary display panel further comprises a third auxiliary display panel slidably extendable from a storage position within the housing to a use position through the slot in the one of the top or bottom sides having a slot.

10. The display of claim 1 further comprising:
a signal input for receiving content to be displayed on the display;
a memory storing a computer program;
a digital processing apparatus coupled to the sensor, signal input and memory, wherein when the computer program is executed by the digital processing apparatus the following operations are performed:
receiving a message from the sensor, wherein the message comprises at least data concerning the level of extension of the at least one auxiliary display; and
allocating the content for display on the main and auxiliary displays in dependence on the message received from the sensor.

11. An electronic device comprising:
a display having a variable display size, the display comprising:
a housing having a front side, a back side, two lateral sides, top and bottom sides, wherein at least one of the top, bottom or lateral sides has a slot, the front, back, lateral, top and bottom sides defining a hollow cavity within the housing;
a main display panel mounted on the front side of the housing;
at least one auxiliary display panel slidably extendable from a storage position within the hollow cavity of the housing, the at least one auxiliary display panel mounted on a slider mounting, wherein the at least one auxiliary display panel slides through the slot to a use position and slides back through the slot to the storage position when not in use, and wherein a variable amount of the at least one auxiliary display panel is available for display purposes depending on how far the at least one auxiliary display panel is extended when in use; and
at least one sensor for detecting a current position of the at least one auxiliary display panel, wherein when in a storage position the sensor generates a message indicating that the at least one auxiliary display panel is in a storage position and not available for display purposes, and when in a use position, the sensor detects how far the at least one auxiliary display panel is extended, the level of extension indicating an amount of the at least one auxiliary panel which is visible and available for display purposes and the sensor generates a message indicating the level of extension;
a content generating component to generate content for display on the display;
a memory storing a computer program;
a digital processing apparatus for executing the computer program, wherein when the computer program is executed the following operations are performed:
if the at least one auxiliary display panel is in a storage position:
receiving a message from the sensor indicating that the at least one auxiliary display panel is in a storage position; and
allocating the content for display to the main display panel; and
if the at least one auxiliary display panel is in a use position:
receiving a message from the sensor indicating the level of extension of the at least one auxiliary display panel; and
allocating the content for display to the main display panel and the at least one auxiliary display panel in dependence on the message.

12. The electronic device of claim 11 wherein the electronic device comprises a notebook computer.

13. The electronic device of claim 11 wherein the two lateral sides have slots and the at least one auxiliary display panel further comprises two auxiliary display panels, the two auxiliary display panels being slidably extendable from storage positions to use positions through the slots in the two lateral sides.

14. The electronic device of claim 13 wherein the two auxiliary display panels are each pivotally mounted on pivot mounts, wherein the pivot mounts are coincident with axes, and wherein when maximally extended the two auxiliary display panels are operable to pivot about their respective axes.

15. The electronic device of claim 11 wherein the slider mounting further comprises a slide retention mechanism for retaining the at least one auxiliary display panel at a particular level of extension when the at least one auxiliary display panel is in use.

16. The electronic device of claim 11 wherein the electronic device comprises a personal digital assistant.

17. The electronic device of claim 11 wherein the electronic device comprises a global positioning system device

18. The electronic device of claim 11 wherein the electronic device comprises a portable DVD player.

19. The electronic device of claim 11 wherein the electronic device comprises a portable computer game playstation.

20. A signal-bearing medium tangibly embodying a program of machine-readable instructions executable by a digital processing apparatus of a computer system to perform operations for controlling display operations across a composite display comprised of a main display panel and at least one auxiliary display panel of variable dimensions, the operations comprising:
receiving a signal indicating that the at least one auxiliary panel has been extended;
receiving a signal indicating how much of the at least one auxiliary panel has been extended, wherein the main display panel and the extended portion of the at least one auxiliary display panel form a new effective display; and
allocating content for display to the extended portion of the at least one auxiliary display panel and the main display panel.
